(19) United States
(12) Patent Application Publication
(10) Pub. No.: US 2018/0029844 A1
(43) Pub. Date: Feb. 1, 2018

(54) FASTENING ARRANGEMENT AND HOOK FOR THE TRANSPORT OF OBJECTS

(71) Applicant: GKS STAHL- UND MASCHINENBAU GMBH, Langenfeld (DE)

(72) Inventor: Soeren FRANKE, Haan (DE)

(21) Appl. No.: 15/224,796

(22) Filed: Aug. 1, 2016

(51) Int. Cl. B66C 1/42

(52) U.S. Cl. CPC B66C 1/42

(57) ABSTRACT

Disclosed is a fastening arrangement for a hook for the transport of an object. The arrangement comprises at least one hook mouth and at least one rotatably mounted load support. The load support is a radial segment which rests on the hook in the hook mouth and together therewith forms a load-supporting bearing, at least one inner face of the hook in the hook mouth forming a bearing shell and corresponding to the radial segment. The hook bears against a flange of an object, and at least one stop element is provided, which is arranged in a region of the flange of the object opposite the hook. Also disclosed is a hook for use in the arrangement.

### BACKGROUND OF THE INVENTION

### 1. Field of the Invention

The invention relates to a fastening arrangement for a hook for the transport of objects and to a hook having at least one hook mouth and at least one rotatably mounted load support, wherein the load support is a radial segment which rests on the hook in the hook mouth and together therewith forms a load-supporting bearing. The hook is a load hook within the sense of the invention.

### 2. Discussion of Background Information

Various hooks are known for the transport of objects, in particular coil hooks, which have a tiltable load support. This is clear for example from DE 20 2005 024 671, the entire disclosure of which is incorporated by reference herein. In the case of hooks of this type, the pivot point of the load support is outside the center point of the hook, specifically at the outer end of the lower limb of the hook. When receiving loads, the load support is considerably loaded in the tilted state, in particular in the region of the pivot point. This leads to a substantial increase of the bearing friction. In addition, the substantially vertical position of the hook also changes, such that a canting can occur in the region of a hook fastening. The hook itself, when under load, does not adjust itself in the direction of the force effect of the object to be transported. In this respect there is an unfavorable force uptake and force distribution.

This is based on the fact that the axis of the load support and also a virtual axis of the hook mouth or the center point of the hook are distanced far from one another.

In addition, it is of great disadvantage that the load support, with respect to its horizontal normal position, can be pivoted, i.e. tilted, only in one direction. Only a unilateral tilting motion away from the hook mouth is possible. A rotational motion bilaterally, centered in the hook mouth, is not provided.

This is also the case with the solution disclosed in EP 1953111 A2, the entire disclosure of which is incorporated by reference herein. In addition, the solution there, as before, requires an additional shaft as load-supporting bearing. Due to the shaft, only smaller forces can be taken up there, because the entire load support and orientation in the direction of the force effect of the object to be received act on the relatively weak shaft.

In order to carry certain objects, such as coils, the known solutions are generally sufficient, but also have disadvantages, as described hereinafter. if, however, other objects are to be transported, in particular objects of which the height exceeds the width many times (e.g. at least 10 times, at least 20 times, or at least 50 times) over and objects with which there is a significant change to the position during the transport process, the solution with only unilateral pivotability has proven to be very disadvantageous. In addition, the negative phenomena with regard to the previously described force uptake and force development are observed there to a significant extent. In the extreme case, the hook or the object to be transported may become deformed or destroyed.

Tower segments for wind turbines are transported practically horizontally on account of their large length and must be maneuvered into a vertical position for construction.

Two cranes are usually used for this purpose. A plurality of hooks of a larger crane grasp a first flange of the tower segment. A further flange of the tower segment is grasped by a conventional hook or a screwed stop of a further crane.

When maneuvering the tower segment, very high bending forces occur at the further flange of the tower segment bearing against the hook or stop and can lead to a deformation of the tower segment or of the support surfaces. The hook may also be damaged so to speak.

Precisely in this case, it is particularly disadvantageous that the hook, under load, does not adjust itself in the direction of the force effect of the article to be transported, here the tower segment.

There is also a development of force at a certain point in the region of the support surface of the hook at the further flange when only the hook is arranged on the flange. In the case of the tubular objects concerned here, in particular in the case of tower segments of a wind turbine, this may lead to deformations on account of the force of gravity, such that these objects at the flange are no longer radially symmetrical, but become un-round.

It would be advantageous to be able to overcome the disadvantages of the prior art and to provide a hook for the transport of objects and a fastening arrangement, with which an improved uptake and distribution of the forces acting on the hook and the object can be ensured. In addition, it would also be advantageous for the objects to be better protected when supported on the ground.

### SUMMARY OF THE INVENTION

The present invention provides a fastening arrangement for a hook for the transport of an object, which arrangement comprises at least one hook mouth and at least one rotatably mounted load support. The load support is a radial segment which rests on the hook in the hook mouth and together therewith forms a load-supporting bearing. At least one inner face of the hook in the hook mouth forms a bearing shell and corresponds to the radial segment. The hook bears against a flange of the object and at least one stop element is provided, which is arranged in a region of the flange of the object opposite the hook.

In one aspect of the fastening arrangement, the hook may be braced by the at least one stop element during a transport process with the flange of the object.

in another aspect, the at least one stop element may be fixed to the flange by at least one stop point. The at least one stop point may comprise an edge protection, which may be arranged on a support side at both flanges of the object.

In yet another aspect of the arrangement of the present invention, the at least one stop element may bear against the hook mouth or against the radial segment.

In a still further aspect, the at least one stop element may be arranged in the region of the flange of the object opposite the hook at least at two points symmetrical with respect to the hook.

In another aspect, the load support of the hook, as radial segment, may be multilaterally pivotable starting from a horizontal position of a load support surface of the radial segment.

In another aspect, the radial segment of the hook may be mounted rotatably in the hook mouth in at least one guide of the hook that receives the radial segment.

The present invention also provides a hook for the transport of an object, which hook comprises at least one hook mouth and at least one rotatably mounted load support. The load support is a radial segment which rests on the hook in the hook mouth and together therewith forms a load-supporting bearing. At least one inner face of the hook in the hook mouth forms a bearing shell and corresponds to the radial segment, and at least one stop element for arrangement in a region of a flange of the object opposite the hook is provided on the hook.

In one aspect of the hook, the at least one stop element may be rigid or flexible and may comprise, at its free ends or its free end, at least one stop point. The at least one stop point may comprise an edge protection

In another aspect of the hook, the at least one stop element may comprise, in each case, a tie-down device.

In yet another aspect of the hook, the at least one stop element may be configured to be able to rest on the hook mouth or on the radial segment.

As set forth above, the hook for the transport of objects is embodied with a hook mouth and a rotatably mounted load support in such a way that the load support is formed by a radial segment—i.e. a separate component, which rests on the hook in the hook mouth and together therewith forms a load-supporting bearing. The load support as radial segment is in this case multilaterally pivotable starting from a horizontal position of a load support surface of the radial segment. Within the scope of the invention, special embodiments of the hook can also comprise a plurality of hook mouths and a plurality of load supports.

In accordance with the invention a plain bearing or a needle bearing is contemplated as load-supporting bearing. Here, needle bearings are contemplated only when lower force effects are produced by the object to be transported.

Within the scope of the invention at least an inner face of the hook in the hook mouth forms a bearing shell corresponding to the radial segment. This is to be understood to mean that both the bearing shell of the hook and radial segment have the same or practically the same radius, such that one or more inner faces of the hook in the hook mouth and at least an outer face of the radial segment (lateral surface) form surfaces sliding over one another, which are matched to one another. The radial segment and hook form a plain bearing in this regard.

The inner face of the hook in the hook mouth is preferably provided, as bearing shell, with a bearing layer, preferably a bearing metal (white metal, bronze, red brass, etc.). Here, further component parts of the hook itself form a protective shell, since the material of the hook is generally much more stable, but has poorer sliding properties, than the bearing metal. A composite plain bearing is also conceivable.

Within the scope of the invention the radial segment is mounted rotatably in the hook mouth in at least one guide receiving the radial segment. The load support, as radial segment, is multilaterally pivotable here, i.e. within the guide of the hook, starting from a horizontal position of a load support surface of the radial segment.

In this context, the guide of the hook can be embodied as a rail support or as a rail. The radial segment has at least one rail or at least one rail support. Within the scope of the embodiment of the invention, one of the two components, either the radial segment or the guide of the hook, consequently has at least one rail or at least one rail support or is formed as such.

These cooperate such that the rail is mounted movably in the rail support. An axial movement of the radial segment in the hook mouth is thus minimized and is possible only within the scope of the play between rail and rail support. Here, it should be mentioned that in the case of a plurality of rail supports and rails, the area over which the radial segment rests on the hook in the hook mouth can be reduced. Here, the frictional force can be reduced in spite of a large force uptake.

In a further embodiment of the invention at least one rail support or at least one rail has a recess shaped in the form of a segment of a circle, in which recess at least one securing element of the rail or of the rail support engages. This serves to limit a pivoting motion in the bilateral direction of rotation and to hold the radial segment reliably in the hook mouth.

In accordance with the invention the radial segment, as load support, has at least one recess for load uptake. However, a plurality of recesses are also conceivable, such that, for special objects which have to be transported, particular designs for load uptake are possible. In this context, the load support has at least one load support surface. The load support surface can also be provided with different radii or elevations, for example nubs, in order to ensure an improved load uptake.

If a plurality of load support surfaces are provided, these are arranged at a defined angle to one another corresponding to the objects to be transported. It is thus ensured that the object is received in the hook in an optimal manner. In one embodiment of the invention two load support surfaces are provided, which are arranged at right angles to one another.

What is known as a C-hook is generally used as a hook for the transport of objects. Other hook designs, however, are also possible within the scope of the invention.

The hook for the transport of objects is used preferably for the transport of objects with which there is a considerable change in position during the transport process. The hook is particularly suitable for the transport of objects of which the height exceeds the width many times over and which are maneuvered from a practically horizontal position in the event of assembly. This is the case with tower segments, in particular those for wind turbines.

Furthermore, the radial segment can be exchangeable, such that a simple and easy adaptation to the objects to be transported in accordance with the particular transport situation is possible.

In a further embodiment of the invention at least one stop element for arrangement in a region of a flange of the object to be transported opposite the hook is provided on the hook. This stop element is used for the fastening arrangement according to the invention for the transport of objects, wherein the term ‘objects’ is to be understood to mean large tubular segments, such as tower segments of wind turbines. Within the scope of this fastening arrangement, the hook bears against a flange of a tower segment of this type, generally a further flange as described in the introduction. The at least one stop element is provided, that is to say fixed or fixable, on the hook and, in the case of the fastening arrangement, is arranged in the region of the flange opposite the hook.

The one or more stop elements is/are preferably arranged in the region of the flange opposite the hook at the two points symmetrical with respect to the hook. This means that the distance between the two points from a virtual vertical starting from the hook is the same. This leads to an even further improved and more uniform development of forces acting on the object during transport.

The hook is then braced by means of the at least one stop element during a transport process (lifting and manoeuvring) with the flange of the object, i.e. the tower segment. This is the case when the hook is in the functional position and the crane for its part grasps the object via the hook. By means of a bracing of this stop element, for example ropes, with the region of the flange opposite the hook, a better-distributed development of force is ensured, especially when only the hook bears via its load support surface against the object, that is to say against the tower segment in the functional position. This prevents a deformation of the flange, even though this may only be very small. This risk is at least mitigated. The bracing is generally implemented via a tie-down device of a respective stop means. With use of at least one rigid stop element, a bracing can also be omitted. This at least one stop element is then matched to the object to be contacted so as to be arranged at the flange thereof in the region opposite the hook.

One or two stop elements is/are generally used. However, as presented, just one stop element is also sufficient. It is provided in a manner resting on the hook mouth or on the radial segment as a loose component or is already arranged there and bears there in the case of the fastening arrangement.

The at least one stop element is either rigid or flexible. Flexible stop elements, such as ropes or chains, are generally used. The one or more stop element has/have, at its/their free ends or at just one end, when just one stop element is provided, which for example is inserted in a looped manner into the hook mouth, or at its/their free end when two or more are used, at least one stop point for fixing to the flange. The at least one stop element is fixed to the flange via the at least one stop point in the fastened state. Here, the at least one stop point can have an edge protection, preferably on the support side, in order to better protect the object, especially when there is a risk of the object being set down on the ground during a transport process. The edge protection, however, can also be used separately as a component without stop point. It is then arranged on both sides on the support side on flanges of the object to be transported, i.e. tower segments of a wind turbine. In addition, it can be easily removed when required by the assembly process. An edge protection of this type then serves as a support surface for a ground-level tower segment. The term “on the support side” means an arrangement in the region of the support surface of the object when this lies horizontally on a surface, i.e. the earth's surface. The edge protection can be specially designed for this purpose. If, specifically, a tower segment of a wind turbine is removed from its transport frame and prepared for manoeuvring, there are often no suitable support rests available. Tower segments are therefore more often placed on simple pallets, whereby there is a risk of damage to the surface. The edge protection on the support side can at least minimize this. In the case of the fastening arrangement, the edge protection is therefore advantageously arranged on both flanges of a tower segment, which ensures an improved protection of the surface. Here, it should be noted that the edge protection is preferably arranged already on the flanges of the tower segment when the tower segment is still fixed to the transport frame or before the transport frame is released from the tower segment.

In accordance with the invention a fastening arrangement and a hook are therefore provided, with which a deformation of the object to be transported, in particular a tower segment, is ruled out or considerably reduced. Due to the edge protection, preferably on the support side, damage to the surface can additionally be reduced. In the case of the hook, a bilateral rotational movement of the load support is ensured, and not a unilateral tilting motion leading away from the hook mouth. The load support, as radial segment, can thus be pivoted from a number of sides starting from a horizontal position of a load support surface.

Due to the fact that the axis of the radial segment coincides or substantially coincides with a virtual axis of the hook mouth or the center of the hook, the forces acting on the hook and the object to be transported are taken up and distributed in an optimized manner. If the position of an object to be transported changes during the transport process, this results in a dynamic force development and no longer in a sudden force development. A deformation of the objects to be transported is minimized or prevented.

In accordance with the invention the hook automatically adjusts itself during a lifting process, more specifically the load support as radial segment, under load in the direction of the force effect of the object to be transported.

In addition, on account of the improved force uptake and force development, damage to the hook or load support thereof is likewise minimized.

### BRIEF DESCRIPTION OF THE DRAWINGS

The invention will be explained in greater detail hereinafter on the basis of an exemplary embodiment with reference to the drawings.

In the drawings:

FIG. 1

shows a perspective illustration of a hook for the transport of objects,

FIG. 2

shows a side view of a hook for the transport of objects,

FIG. 3

shows a fastening arrangement according to the invention on a tower segment of a wind turbine, with a view from an end face,

FIG. 4

shows a fastening arrangement according to the invention on a tower segment of a wind turbine, with a view of the lateral surface.

### DETAILED DESCRIPTION OF EMBODIMENTS OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show details of the present invention in more detail than is necessary for the fundamental understanding of the present invention, the description in combination with the drawings making apparent to those of skill in the art how the several forms of the present invention may be embodied in practice.

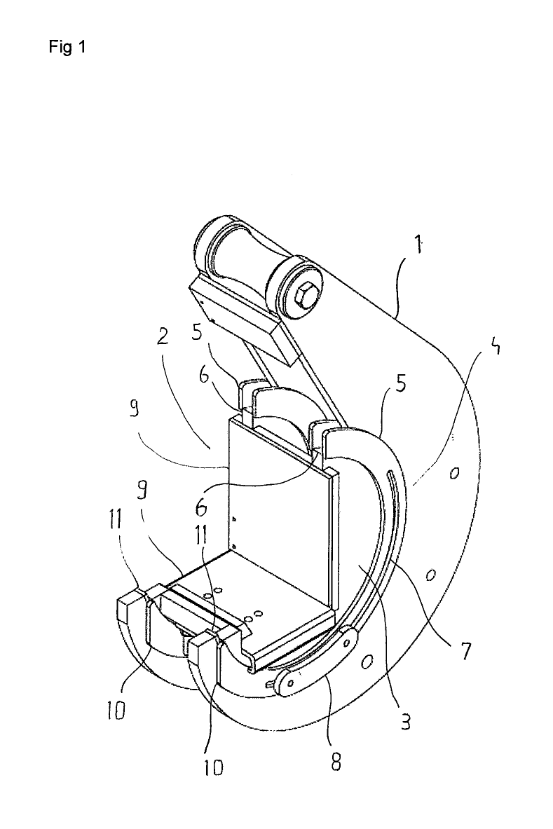

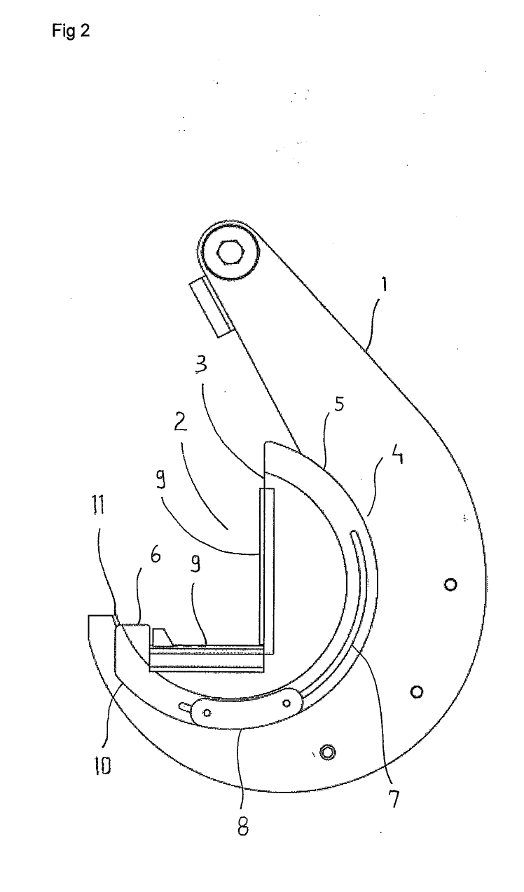

FIG. 1 and FIG. 2 illustrate, schematically, a hook (1) for the transport of objects, having a load support as radial segment (3), which has a recess shaped in the form of a quarter of a circle. Here, the hook (1) is used for the transport of objects of which the height exceeds their width many times over and with which there is a considerable change in position during the transport process; in the exemplary embodiment the objects are tower segments for wind turbines.

The radial segment (3) rests on the hook (1) in the hook mouth (2) and together therewith forms a plain bearing. Here, the hook mouth (2) forms a bearing shell (4), which has a bearing layer (11) consisting of a bearing metal, red brass in the exemplary embodiment. The hook (1) itself forms a protective shell here, which receives the softer bearing metal, which has better sliding properties.

The radial segment (3) is mounted in the hook mouth (2) in two guides (10) receiving the radial segment (3), the two guides (10) being embodied as rail supports (5). The radial segment (3) in the exemplary embodiment has two rails (6), which are part of the radial segment (3).

Here, support surfaces of the two rails (6) form the outer surfaces of the radial segment (lateral surface), which rest on the hook (1) in the hook mouth (2) and are rotatably mounted by the rail supports (5) in such a way that an axial movement of the radial segment (3) in the hook mouth (2) is minimized and can only occur within the scope of the play between rails (6) and rail supports (5). Both rail supports (5) each have a recess (7) shaped in the form of a segment of a circle, said recesses being shaped in the form of approximately a quarter of a circle. Due to the two narrow rails (6) of the radial segment (3), which rest on the hook (1) in the hook mouth (2), the support surface and therefore the frictional force is reduced. Nevertheless, reliability is provided within the scope of the invention. One of the two rails (6) of the radial segment (3) has a securing element (8), which consists of two pins and a securing strip. The securing element (8) engages in the recess (7) in the shape of a segment of a circle in one of the rail supports (5). The direction of rotation of the radial segment (3) in the hook mouth (2) is not limited, and the radial segment (3) is secured from falling out of the hook mouth (2).

The load support has, as radial segment (3), as presented in the introduction, a recess shaped in the form of a quarter of a circle having two load support surfaces (9), which are arranged at right angles to one another. The object to be transported is set down or laid thereon.

During a working process, generally a lifting process, the hook (1) grasps an object, such that part of the object rests on the load support surface (9). The load support, as radial segment (3), then automatically adjusts itself in the event of a change in position of the object, under load, in the direction of the force effect of the object.

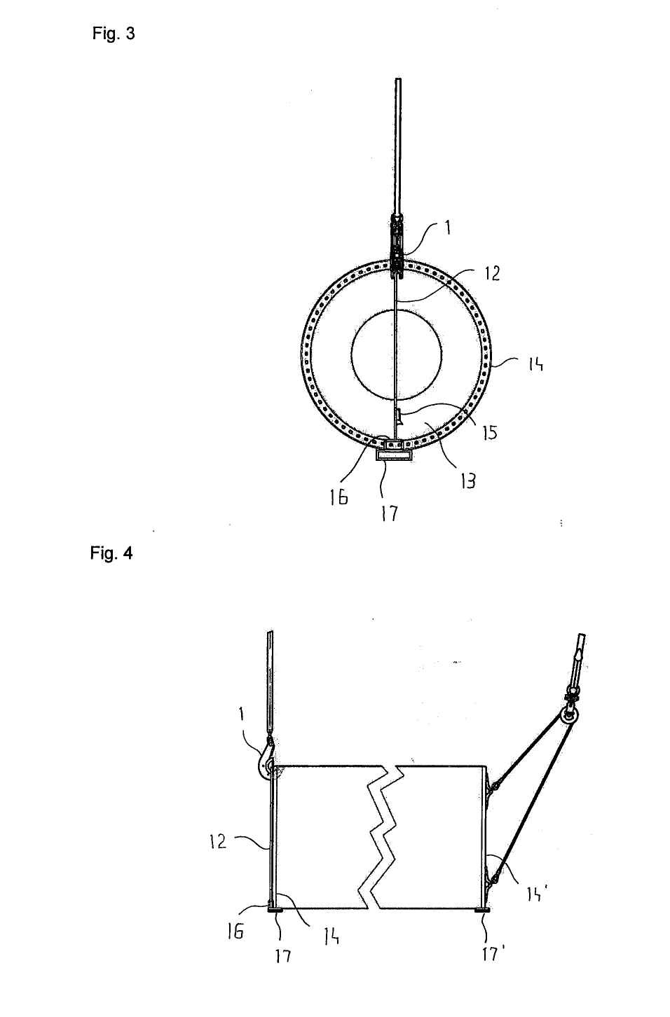

According to FIG. 3 and FIG. 4, a stop element 12 for arrangement in a region 13 of a flange 14 of the object opposite the hook 1 is provided on the hook 1. Within the scope of the fastening arrangement, the hook 1 bears against the flange 14 of a tower segment. The stop element 12 fixed to the hook 1 is arranged in the region 13 of the flange 14 opposite the hook 1 at a particular point. The stop element 12 is arranged here at the radial segment 3.

The hook 1 is braced by means of the stop element 12 via a tie-down device 15 with the flange 14 of the tower segment in a functional position. A bracing of the stop means in the form of a rope with the region 13 of the flange 14 opposite the hook is thus ensured, which ensures a better-distributed development of force when only the hook 1 bears via its load support surface 9 against the tower segment and the tower segment is lifted and maneuvered. As already presented in the introduction, this prevents a deformation of the flange 14.

The at least one stop element 12 also has a stop point 16 for fixing to the flange 14. The stop point 16 has an edge protection 17 in order to better protect the tower segment during transport. The edge protection 17 in the exemplary embodiment according to FIG. 4 is also used separately as a component without stop point 16. The edge protection 17 is arranged on both sides and, significantly, is arranged at the flanges 14 and 14′ of the tower segment on the support side. The edge protection serves as a support surface for the as yet unmaneuvered, horizontally arranged tower segment, which is thus in a lying position. When the tower segment is removed from its transport frame and is prepared for assembly, the edge protection 17 serves as a support rest for the tower segment, which is still in a lying position, because separate rests of this type are often unavailable during an assembly process.

### LIST OF REFERENCE NUMBERS

1 Hook
2 hook mouth
3 radial segment
4 bearing shell
5 rail support
6 rail
7 recess shaped in the form of a segment of a circle
8 securing element
9 load support surface
10 guide
11 bearing layer
12 stop element
13 opposing region
14 flange
15 tie-down device
16 stop point
17 edge protection

1. A fastening arrangement for a hook for the transport of an object, wherein the arrangement comprises at least one hook mouth and at least one rotatably mounted load support, the load support being a radial segment which rests on the hook in the hook mouth and together therewith forms a load-supporting bearing, at least one inner face of the hook in the hook mouth forming a bearing shell and corresponding to the radial segment, and wherein the hook bears against a flange of an object, and at least one stop element is provided, which is arranged in a region of the flange of the object opposite the hook and whose design is different from that of the hook.

2. The fastening arrangement of claim 1, wherein the hook is braced by the at least one stop element during a transport process with the flange of the object.

3. The fastening arrangement of claim 1, wherein the at least one stop element is fixed to the flange by at least one stop point.

4. The fastening arrangement of claim 3, wherein the at least one stop point comprises an edge protection.

5. The fastening arrangement of claim 1, wherein the at least one stop element bears against the hook mouth.

6. (canceled)

7. The fastening arrangement of claim 1, wherein the load support of the hook, as radial segment, is multilaterally pivotable.

8. The fastening arrangement of claim 1, wherein the radial segment of the hook is mounted rotatably in the hook mouth in at least one guide of the hook receiving the radial segment.

9. (canceled)

10. A hook for the transport of objects, wherein the hook comprises at least one hook mouth and at least one rotatably mounted load support, the load support being a radial segment which rests on the hook in the hook mouth and together therewith forms a load-supporting bearing, at least one inner face of the hook in the hook mouth forming a bearing shell and corresponding to the radial segment, and at least one stop element for arrangement in a region of a flange of the object opposite the hook being provided on the hook, the at least one stop element being of a design which is different from that of the hook.

11. The hook of claim 10, wherein the at least one stop element is flexible and comprises, at its free ends or its free end, at least one stop point.

12. The hook of claim 10, wherein the at least one stop element comprises a tie-down device.

13. The hook of claim 11, wherein the at least one stop point has an edge protection.

14. The hook of claim 10, wherein the at least one stop element is configured to be able to rest on the hook mouth or on the radial segment.

15. A method of transporting an object, wherein the method comprises transporting the object by using a hook with the fastening arrangement of claim 1.

16. The method of claim 15, wherein the object is a tower segment of a wind turbine.

17. A method of transporting an object, wherein the method comprises transporting the object by using the hook of claim 10.

18. The method of claim 17, wherein the object is a tower segment of a wind turbine.

19. The hook of claim 10, wherein the at least one stop element is rigid and comprises, at its free ends or its free end, at least one stop point.

20. The fastening arrangement of claim 1, wherein the at least one stop element is rigid and comprises, at its free ends or its free end, at least one stop point.

21. The fastening arrangement of claim 1, wherein the at least one stop element is flexible and comprises, at its free ends or its free end, at least one stop point.

22. The fastening arrangement of claim 1, wherein the at least one stop element bears against the radial segment.
